(19) United States
(12) Patent Application Publication
(10) Pub. No.: US 2019/0155407 A1
(43) Pub. Date: May 23, 2019

(54) LIGHT GUIDE ELEMENT AND ELECTRONIC DEVICE USING THE SAME

(71) Applicant: Primax Electronics Ltd., Taipei City (TW)

(72) Inventor: Ming-Hui Yeh, Taipei City (TW)

(21) Appl. No.: 15/907,846

(22) Filed: Feb. 28, 2018

(30) Foreign Application Priority Data
Nov. 17, 2017 (TW) 106139926

(51) Int. Cl. G06F 3/0354; G06F 3/03

(52) U.S. Cl. CPC G06F 3/03543; G06F 3/0383; G06F 2203/0337; G06F 3/0317

(57) ABSTRACT

A light guide element includes a soft-light part and a light-transmissible part. The light-transmissible part is connected with the soft-light part. After plural light beams enters the soft-light part through a first soft-light part surface, the plural light beams are uniformly diffused by plural scattering particles of the soft-light part, and first-portion light beams of the plural light beams are exited from the soft-light part through a second soft-light part surface. The first-portion light beams enter the light-transmissible part through ae first light-transmissible part surface. A third light-transmissible part surface is a polished flat surface and arranged between the first light-transmissible part surface and the second light-transmissible part surface. After the first-portion light beams enter the light-transmissible part, a large proportion of the first-portion light beams are exited from the light-transmissible part through a second light-transmissible part surface.

### FIELD OF THE INVENTION

The present invention relates to an optical element, and more particularly to a light guide element and an electronic device using the light guide element.

### BACKGROUND OF THE INVENTION

With the development of electronic industries and the advance of industrial technologies, various electronic products are designed toward small size, light weightiness and easy portability. Consequently, these electronic products can be applied to mobile business, entertainment or leisure purposes whenever or wherever the users are. Recently, people pay much attention to the integrations and applications of mechanical, optical and electrical technologies. Consequently, a variety of illuminating modules are widely applied to many products. For example, a light emitting diode and/or a light guide plate is applied to a mouse device, a keyboard device or any other pointing/input device. Consequently, the mouse device or the keyboard device has the illuminating function.

FIG. 1 schematically illustrates the concepts of a conventional illuminating module. As shown in FIG. 1, the conventional illuminating module 1 comprises a light emitting diode 11 and a light guide element 12. For example, the light guide element 12 is made of polymethylmethacrylate (PMMA), polycarbonate(PC), polystyrene (PS), polypropylene (PP) or acrylonitile-butadiene-styrene (ABS). Moreover, the light guide element 12 comprises plural scattering particles 121. For succinctness, only some scattering particles 121 are shown in the drawing. The light emitting diode 11 emit plural light beams L11. The light beams L11 enter the light guide element 12 through an incident surface 122 of the light guide element 12. Due to the scattering particles 121 of the light guide element 12, the light beams L11 are continuously refracted, reflected and scattered between two media with different refraction indexes. Consequently, the light beams L11 are uniformly diffused to the whole light guide element 12. That is, except for the incident surface 122, the other surfaces of the light guide element 12 are illuminating surfaces. That is, the light beams L11 can be outputted from the illuminating surfaces.

FIG. 2 is a schematic perspective view illustrating a conventional mouse device with an illuminating function and taken along a viewpoint. FIG. 3 is a schematic perspective view illustrating the conventional mouse device as shown in FIG. 2 and taken along another viewpoint. The mouse device 2 comprises a mouse body 23, a circuit module (not shown), a light emitting diode (not shown) and a light guide element 22. The circuit module and the light emitting diode are disposed within the mouse body 23. While the mouse body 23 is held and moved by the user, the circuit module issues a corresponding pointing signal to provide a pointing function. A portion of the light guide element 22 is disposed within the mouse body 23. Another portion of the light guide element 22 is exposed outside the mouse body 23. For example, the exposed position of the light guide element 22 includes the surfaces P21 and P22. The operations of the light emitting diode and the light guide element 22 are similar to those of the light emitting diode 11 and the light guide element 12 as shown in FIG. 1. After the light emitting diode provides the light beams, the surfaces of the light guide element 22 excluding the incident surface are illuminating surfaces. For example, the surfaces P21 and P22 are the illuminating surfaces. Consequently, the mouse device 2 has the illuminating function.

However, the conventional mouse device still has some drawbacks. For example, in some scenarios, the user prefers the light guide element to generate different visual feels. For example, the surface P21 is illuminated, but the surface P22 is not illuminated. In other words, in case that the surfaces of the light guide element 22 excluding the incident surface are illuminating surfaces, the visual feel cannot meet the requirements of some users. For solving the above drawbacks, some approaches were provided. In accordance with an approach, the mouse device is further equipped with a light-shading plate on the surface P22. As known, the light-shading plate is detrimental to the overall appearance of the mouse device 2. In accordance with another approach, the light guide element is made of polymethylmethacrylate (PMMA), polycarbonate(PC), polystyrene (PS), polypropylene (PP) or acrylonitile-butadiene-styrene (ABS), but the light guide element does not contain the scattering particles. Under this circumstance, a greater portion of the light beams from the light emitting diode can be outputted from the surface P21 of the light guide element. However, the user may visually feel that the surface P21 of the light guide element is a combination of plural light spots rather than a complete illuminating surface.

In other words, the conventional light guide element and the electronic device using the light guide element need to be further improved.

### SUMMARY OF THE INVENTION

An object of the present invention provides a light guide element. The user may visually feel that the surfaces of the light guide element excluding the incident surface are not all illuminating surfaces.

Another object of the present invention provides an electronic device using the light guide element of the present invention.

In accordance with an aspect of the present invention, there is provided a light guide element. The light guide element includes a soft-light part and a light-transmissible part. The soft-light part includes a first soft-light part surface, a second soft-light part surface and plural scattering particles. After plural light beams enters the soft-light part through the first soft-light part surface, the plural light beams are uniformly diffused by the plural scattering particles, and first-portion light beams of the plural light beams are exited from the soft-light part through the second soft-light part surface. The light-transmissible part is connected with the soft-light part, and includes a first light-transmissible part surface, a second light-transmissible part surface and a third light-transmissible part surface. The first light-transmissible part surface faces the second soft-light part surface. The first-portion light beams enter the light-transmissible part through the first light-transmissible part surface after the first-portion light beams are exited from the second soft-light part surface. At least a portion of the third light-transmissible part surface is a polished flat surface and arranged between the first light-transmissible part surface and the second light-transmissible part surface. After the first-portion light beams enter the light-transmissible part, a large proportion of the first-portion light beams are exited from the light-transmissible part through the second light-transmissible part surface, and a small proportion of the first-portion light beams are exited from the light-transmissible part through the third light-transmissible part surface.

In accordance with another aspect of the present invention, there is provided an electronic device. The electronic device includes a circuit module, at least one light-emitting element and a light guide element. The circuit module provides an electronic function. The at least one light-emitting element provides plural light beams. The light guide element includes a soft-light part and a light-transmissible part. The soft-light part includes a first soft-light part surface, a second soft-light part surface and plural scattering particles. After plural light beams from the at least one light-emitting element enters the soft-light part through the first soft-light part surface, the plural light beams are uniformly diffused by the plural scattering particles, and first-portion light beams of the plural light beams are exited from the soft-light part through the second soft-light part surface. The light-transmissible part is connected with the soft-light part, and includes a first light-transmissible part surface, a second light-transmissible part surface and a third light-transmissible part surface. The first light-transmissible part surface faces the second soft-light part surface. The first-portion light beams enter the light-transmissible part through the first light-transmissible part surface after the first-portion light beams are exited from the second soft-light part surface. At least a portion of the third light-transmissible part surface is a polished flat surface and arranged between the first light-transmissible part surface and the second light-transmissible part surface. After the first-portion light beams enter the light-transmissible part, a small proportion of the first-portion light beams are exited from the light-transmissible part through the third light-transmissible part surface, and a large proportion of the first-portion light beams are exited from the light-transmissible part through the second light-transmissible part surface and outputted from the electronic device.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the concepts of a conventional illuminating module;

FIG. 2 is a schematic perspective view illustrating a conventional mouse device with an illuminating function and taken along a viewpoint;

FIG. 3 is a schematic perspective view illustrating the conventional mouse device as shown in FIG. 2 and taken along another viewpoint;

FIG. 4 schematically illustrates the structure of a light guide element according to an embodiment of the present invention;

FIG. 5 is a schematic exploded view illustrating the light guide element as shown in FIG. 4;

FIG. 6 is a schematic perspective view illustrating an electronic device with the light guide element of the present invention;

FIG. 7 is a schematic perspective view illustrating the mouse device as shown in FIG. 6 and taken along another viewpoint;

FIG. 8 is a schematic perspective view illustrating a portion of the inner structure of the mouse device as shown in FIG. 6;

FIG. 9 is a schematic perspective view illustrating the light guide element of the electronic device as shown in FIG. 6; and

FIG. 10 is a schematic perspective view illustrating the light-emitting element of the electronic device as shown in FIG. 6 and the light guide element of FIG. 9 and taken along another viewpoint.

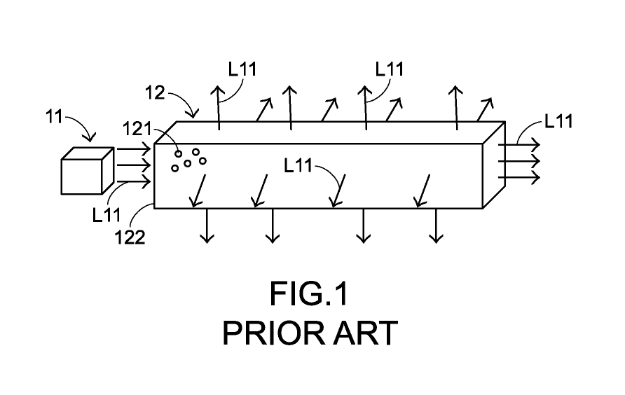

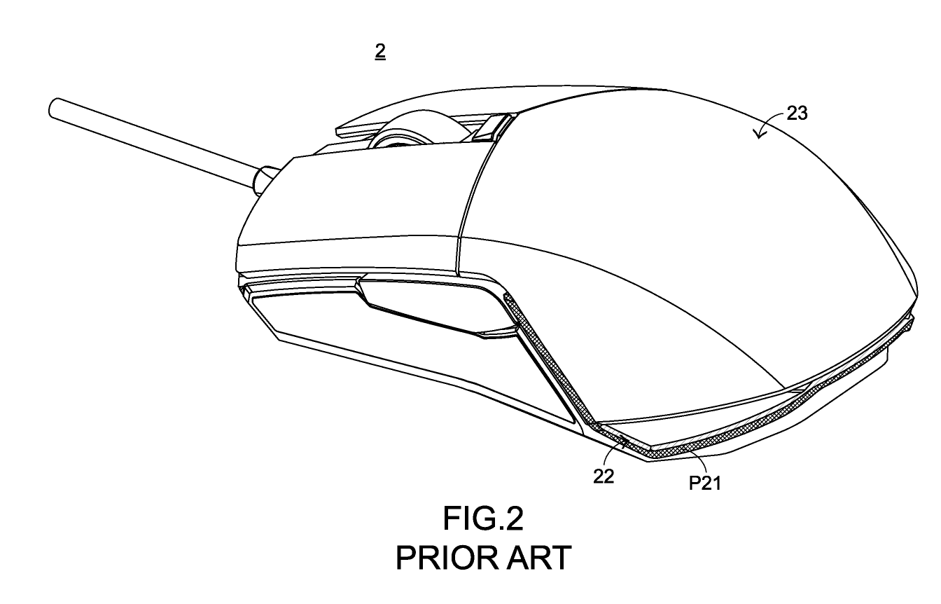

### DETAILED DESCRIPTION OF THE PREFERRED EMBODIMENT

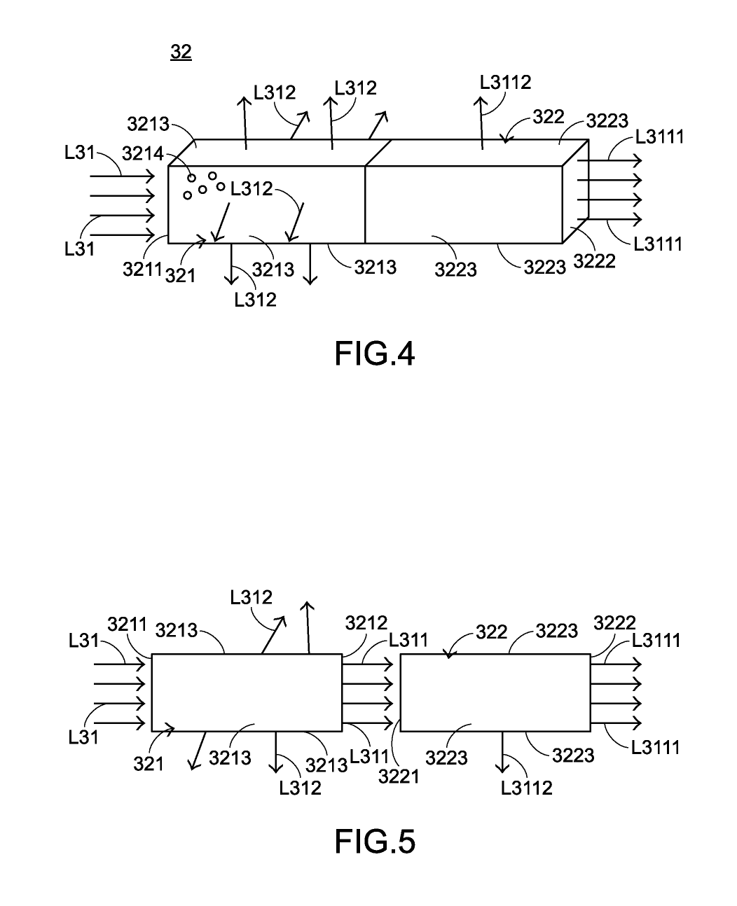

Please refer to FIGS. 4 and 5. FIG. 4 schematically illustrates the structure of a light guide element according to an embodiment of the present invention. FIG. 5 is a schematic exploded view illustrating the light guide element as shown in FIG. 4. In this embodiment, the light guide element 32 comprises a soft-light part 321 and a light-transmissible part 322. The light-transmissible part 322 is connected with the soft-light part 321.

The soft-light part 321 comprises a first soft-light part surface 3211, a second soft-light part surface 3212, a third soft-light part surface 3213 and plural scattering particles 3214. The third soft-light part surface 3213 is arranged between the first soft-light part surface 3211 and the second soft-light part surface 3212. For succinctness, only some scattering particles 3214 are shown in the drawings. The light beams L31 enter the soft-light part 321 through the first soft-light part surface 3211 of the soft-light part 321. Due to the scattering particles 3214 of the soft-light part 321, the light beams L31 are continuously refracted, reflected and scattered between two media with different refraction indexes. Consequently, the light beams L31 are uniformly diffused to the whole soft-light part 321. Moreover, first-portion light beams L311 of the light beams L31 are exited from the soft-light part 321 through the second soft-light part surface 3212, and second-portion light beams L312 of the light beams L31 are exited from the soft-light part 321 through the third soft-light part surface 3213.

The light-transmissible part 322 comprises a first light-transmissible part surface 3221, a second light-transmissible part surface 3222 and a third light-transmissible part surface 3223. The first light-transmissible part surface 3221 faces the second soft-light part surface 3212 of the soft-light part 321. After the first-portion light beams L311 of the light beams L31 are exited from the soft-light part 321 through the second soft-light part surface 3212, the first-portion light beams L311 enter the light-transmissible part 322. Moreover, at least a portion of the third light-transmissible part surface 3223 is a polished flat surface and arranged between the first light-transmissible part surface 3221 and the second light-transmissible part surface 3222. Consequently, after the first-portion light beams L311 enter the light-transmissible part 322, the first-portion light beams L311 are readily subjected to total internal reflection within the space between the first light-transmissible part surface 3221 and the second light-transmissible part surface 3222. In other words, a large proportion (L3111) of the first-portion light beams L311 are exited from the light-transmissible part 322 through the second light-transmissible part surface 3222, and only a small proportion (L3112) of the first-portion light beams L311 that are not subjected to the total internal reflection are exited from the third light-transmissible part surface 3223. Consequently, the user may visually feel that only a specified surface (i.e., the second light-transmissible part surface 3222) is the illuminating surface.

In an embodiment, the soft-light part 321 is made of polymethylmethacrylate (PMMA), polycarbonate(PC), polystyrene (PS), polypropylene (PP) or acrylonitile-butadiene-styrene (ABS), and the scattering particles 3214 of the soft-light part 321 are made of silicon dioxide. In an embodiment, the light-transmissible part 322 is made of polymethylmethacrylate (PMMA), polycarbonate(PC), polystyrene (PS), polypropylene (PP) or acrylonitile-butadiene-styrene (ABS). It is noted that the materials of the soft-light part 321, the scattering particles 3214 and the light-transmissible part 322 are not restricted.

In an embodiment, the soft-light part 321 and the light-transmissible part 322 of the light guide element 32 are produced by using a double injection process. Alternatively, the soft-light part 321 is connected with the light-transmissible part 322 by using a hot melt process such as an ultrasonic hot melt process. Consequently, the light guide element 32 is a single component. From the above description, the light guide element 32 is the single component, and the user may visually feel that the surfaces of the light guide element 32 excluding the incident surface (i.e., the soft-light part surface 3211 of the soft-light part 321) are not all illuminating surfaces. That is, the user visually feels that only a specified surface illuminates. Moreover, since the light beams L31 entering the light guide element 32 have been refracted, reflected and scattered in the soft-light part 321 many times. The user may visually feel that the second light-transmissible part surface 3222 is a complete illuminating surface rather than the combination of plural light spots. It is noted that the process of fabricating the light guide element 32 is not restricted. For example, in another embodiment, the soft-light part 321 and the light-transmissible part 322 of the light guide element 32 are combined together by using a gluing process.

Hereinafter, an electronic device with the light guide element of the present invention will be described as follows. For example, the electronic device is a mouse device, but is not limited thereto. It is noted that numerous modifications and alterations may be made while retaining the teachings of the invention. For example, in another embodiment, the electronic device with the light guide element is a keyboard device.

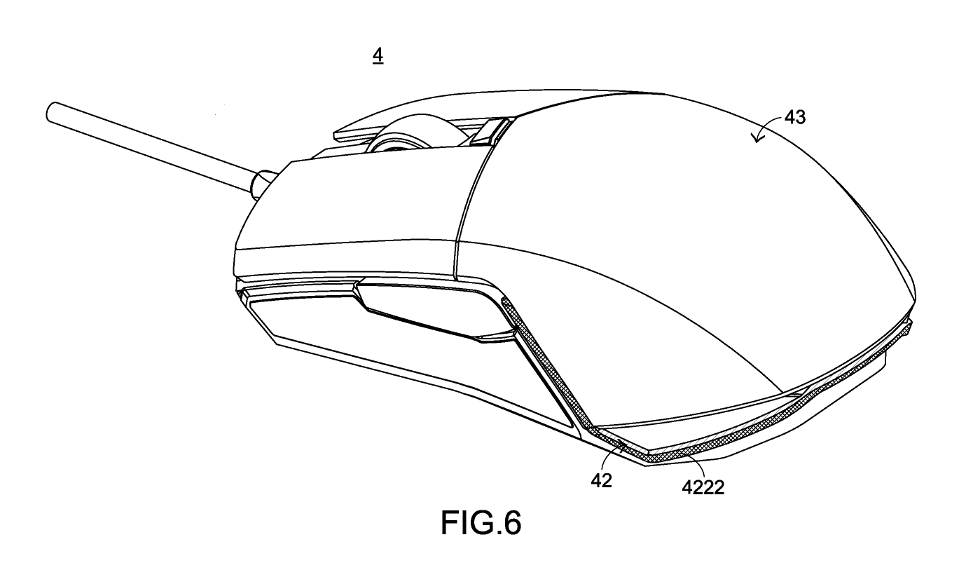

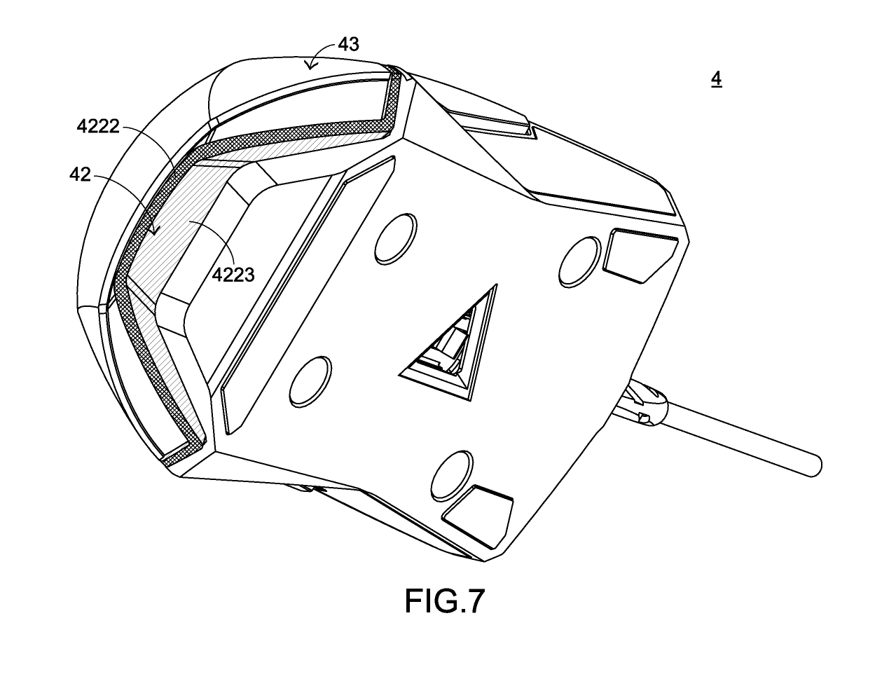

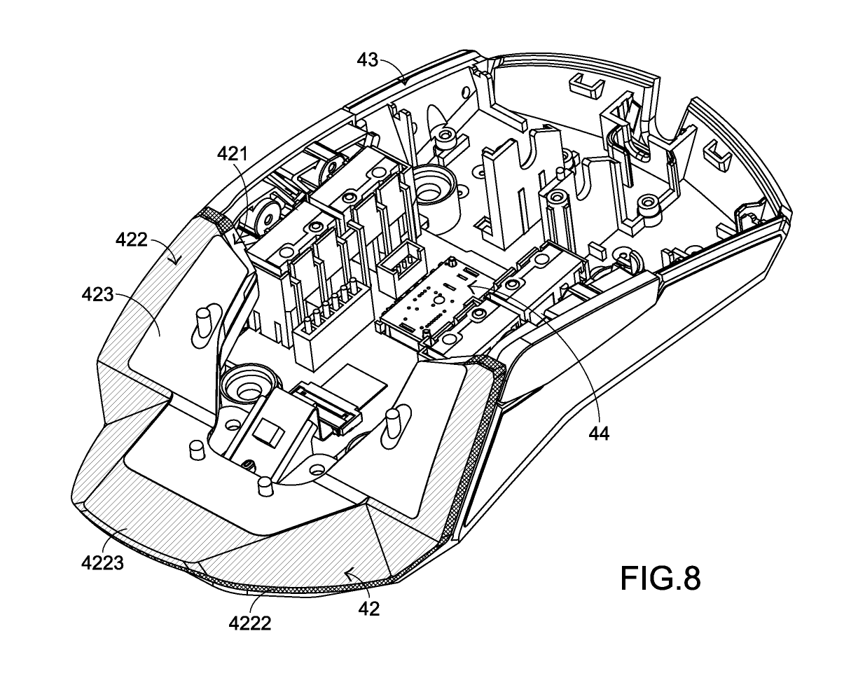

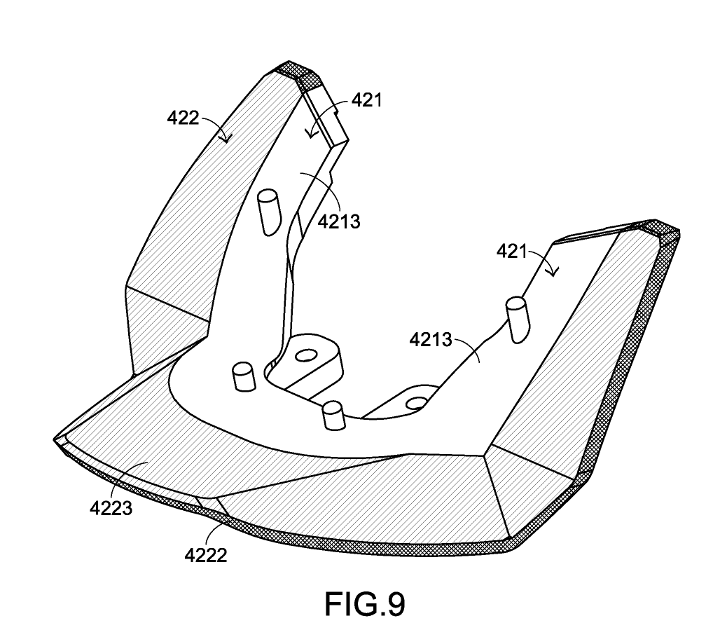

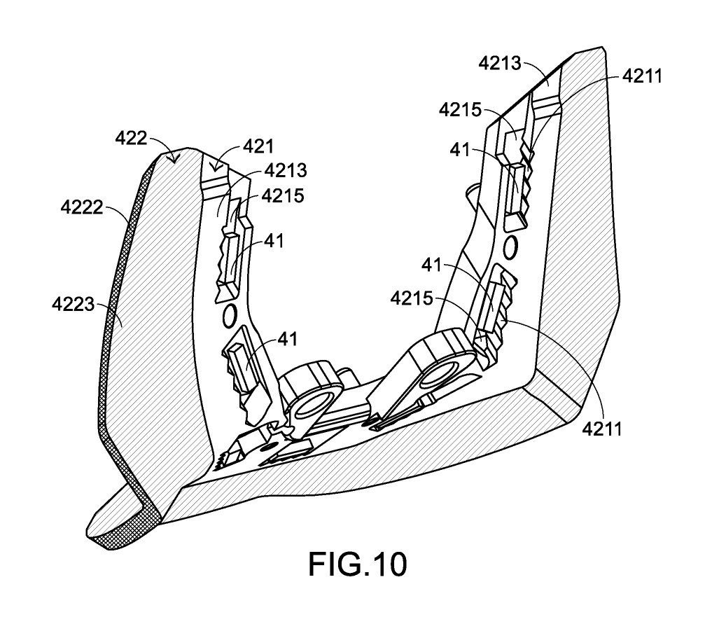

Please refer to FIGS. 6, 7 and 8. FIG. 6 is a schematic perspective view illustrating an electronic device with the light guide element of the present invention. FIG. 7 is a schematic perspective view illustrating the mouse device as shown in FIG. 6 and taken along another viewpoint. FIG. 8 is a schematic perspective view illustrating a portion of the inner structure of the mouse device as shown in FIG. 6. In this embodiment, the electronic device is a mouse device 4. The mouse device 4 comprises a mouse body 43, a circuit module 44, plural light-emitting elements 41 (see FIG. 10) and a light guide element 42. The circuit module 44 and the light-emitting elements 41 are disposed within the mouse body 43. The circuit module 44 is used for providing an electronic function. For example, when the mouse body 43 is held and moved by the user, the circuit module 44 issues a pointing signal to provide a pointing function. A part of the light guide element 42 is disposed within the mouse body 43. Another part of the light guide element 42 is exposed outside the mouse body 43.

Please refer to FIGS. 9 and 10. FIG. 9 is a schematic perspective view illustrating the light guide element of the electronic device as shown in FIG. 6. FIG. 10 is a schematic perspective view illustrating the light-emitting element of the electronic device as shown in FIG. 6 and the light guide element of FIG. 9 and taken along another viewpoint. For clearly illustrating the light guide element 42, the light-transmissible part 422 of the light guide element 42 in FIGS. 8, 9 and 10 are indicated by oblique lines and textured patterns. The region that is not indicated by oblique lines and textured patterns is the soft-light part 421 or the light-shading plate 423. Moreover, in FIG. 10, the light-emitting elements 41 are not indicated by oblique lines and textured patterns.

In this embodiment, the light guide element 42 comprises a soft-light part 421 and a light-transmissible part 422. The light-transmissible part 422 is connected with the soft-light part 421. The soft-light part 421 comprises a first soft-light part surface 4211, a second soft-light part surface, a third soft-light part surface 4213, plural scattering particles and plural recesses 4215. Since the second soft-light part surface is connected with the light-transmissible part 422, the second soft-light part surface is not shown in FIGS. 9 and 10. The third soft-light part surface 4213 is arranged between the first soft-light part surface 4211 and the second soft-light part surface 4212. The scattering particles are similar to the scattering particles as shown in FIG. 4 but not shown in FIGS. 9 and 10. The recesses 4215 correspond to the light-emitting elements 41. The light-emitting elements 41 are accommodated within the corresponding recesses 4215.

The light-emitting elements 41 provide plural light beams. The light beams enter the soft-light part 421 through the first soft-light part surface 4211 of the soft-light part 421. Due to the scattering particles of the soft-light part 421, the light beams are continuously refracted, reflected and scattered between two media with different refraction indexes. Consequently, the light beams are uniformly diffused to the whole soft-light part 421. Moreover, first-portion light beams of the light beams are exited from the soft-light part 421 through the second soft-light part surface, and second-portion light beams of the light beams are exited from the soft-light part 421 through the third soft-light part surface 4213. The operating principles of the soft-light part 421 of the light guide element 42 are similar to those of the soft-light part 321 of the light guide element 32 as shown in FIGS. 4 and 5.

The light-transmissible part 422 comprises a first light-transmissible part surface, a second light-transmissible part surface 4222 and a third light-transmissible part surface 4223. Since the first light-transmissible part surface is connected with the second soft-light part surface of the soft-light part 421, the first light-transmissible part surface is not shown in FIGS. 9 and 10. The first light-transmissible part surface faces the second soft-light part surface of the soft-light part 421. After the first-portion light beams are exited from the soft-light part 421 through the second soft-light part surface, the first-portion light beams enter the light-transmissible part 422. Moreover, at least a portion of the third light-transmissible part surface 4223 is a polished flat surface and arranged between the first light-transmissible part surface 4221 and the second light-transmissible part surface 4222. Consequently, after the first-portion light beams enter the light-transmissible part 422, the first-portion light beams are readily subjected to total internal reflection within the space between the first light-transmissible part surface and the second light-transmissible part surface 4222. In other words, a large proportion of the first-portion light beams are exited from the light-transmissible part 422 through the second light-transmissible part surface 4222 and outputted from the mouse device 4, and only a small proportion of the first-portion light beams that are not subjected to the total internal reflection are exited from the third light-transmissible part surface 4223. The operating principles of the light-transmissible part 422 of the light guide element 42 are similar to those of the light-transmissible part 322 of the light guide element 32 as shown in FIGS. 4 and 5.

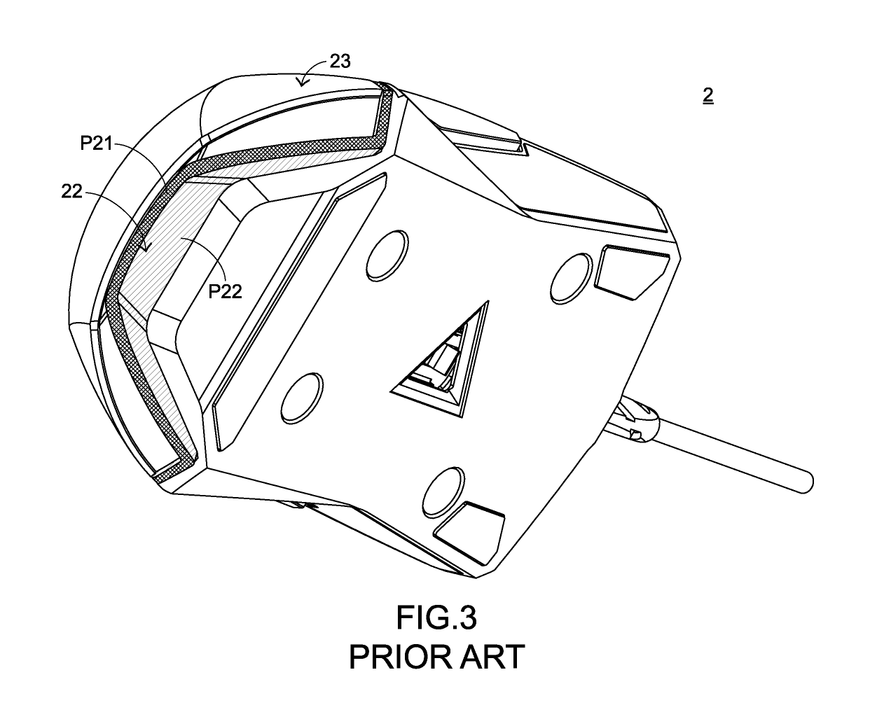

Moreover, since a large proportion of the light beams entering the light-transmissible part 422 are exited from the light-transmissible part 422 through the second light-transmissible part surface 4222, the user may visually feel that only the second light-transmissible part surface 4222 is the illuminating surface. The illuminating way of present invention as shown in FIG. 7 is distinguished from the illuminating way of the conventional mouse device as shown in FIG. 3. As shown in FIG. 3, the user may visually feel that both of the surfaces P21 and P22 illuminate. As shown in FIG. 7, only the second light-transmissible part surface 4222 illuminates. In other words, the technology of the present invention can achieve the efficacy that is not obtained by the conventional technology. Please refer to FIG. 8 again. Optionally, the light guide element 42 further comprises a light-shading plate 423. The light-shading plate 423 is disposed on the third soft-light part surface 4213 of the soft-light part 421 for shading the light beams. Consequently, the light beams are not exited from the soft-light part 421 through the third third soft-light part surface 4213. Under this circumstance, the light utilization efficiency is enhanced.

In an embodiment, the light-emitting elements 41 are light emitting diodes, the soft-light part 421 is made of polymethylmethacrylate (PMMA), polycarbonate(PC), polystyrene (PS), polypropylene (PP) or acrylonitile-butadiene-styrene (ABS), and the scattering particles of the soft-light part 321 are made of silicon dioxide. In an embodiment, the light-transmissible part 422 is made of polymethylmethacrylate (PMMA), polycarbonate(PC), polystyrene (PS), polypropylene (PP) or acrylonitile-butadiene-styrene (ABS). It is noted that the type of the light-emitting elements 41, the materials of the soft-light part 421, the scattering particles and the light-transmissible part 422 are not restricted.

In an embodiment, the soft-light part 421 and the light-transmissible part 422 of the light guide element 42 are produced by using a double injection process. Alternatively, the soft-light part 421 is connected with the light-transmissible part 422 by using a hot melt process such as an ultrasonic hot melt process. Consequently, the light guide element 42 of the mouse device 4 is a single component. From the above description, the light guide element 42 is the single component, and the user may visually feel that the surfaces of the light guide element 42 excluding the incident surface (i.e., the soft-light part surface 4211 of the soft-light part 421) are not all illuminating surfaces. That is, the user visually feels that only a specified surface illuminates. Moreover, since the light beams entering the light guide element 42 have been refracted, reflected and scattered in the soft-light part 421 many times. The user may visually feel that the second light-transmissible part surface 4222 is a complete illuminating surface rather than the combination of plural light spots. It is noted that the process of fabricating the light guide element 42 is not restricted. For example, in another embodiment, the soft-light part 421 and the light-transmissible part 422 of the light guide element 42 are combined together by using a gluing process.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A light guide element, comprising:
a soft-light part comprising a first soft-light part surface, a second soft-light part surface and plural scattering particles, wherein after plural light beams enters the soft-light part through the first soft-light part surface, the plural light beams are uniformly diffused by the plural scattering particles, and first-portion light beams of the plural light beams are exited from the soft-light part through the second soft-light part surface; and
a light-transmissible part connected with the soft-light part, and comprising a first light-transmissible part surface, a second light-transmissible part surface and a third light-transmissible part surface, wherein the first light-transmissible part surface faces the second soft-light part surface, and the first-portion light beams enter the light-transmissible part through the first light-transmissible part surface after the first-portion light beams are exited from the second soft-light part surface, wherein at least a portion of the third light-transmissible part surface is a polished flat surface and arranged between the first light-transmissible part surface and the second light-transmissible part surface, wherein after the first-portion light beams enter the light-transmissible part, a large proportion of the first-portion light beams are exited from the light-transmissible part through the second light-transmissible part surface, and a small proportion of the first-portion light beams are exited from the light-transmissible part through the third light-transmissible part surface.

2. The light guide element according to claim 1, wherein the soft-light part is made of polymethylmethacrylate (PMMA), polycarbonate(PC), polystyrene (PS), polypropylene (PP) or acrylonitile-butadiene-styrene (ABS), or the light-transmissible part is made of polymethylmethacrylate (PMMA), polycarbonate(PC), polystyrene (PS), polypropylene (PP) or acrylonitile-butadiene-styrene (ABS).

3. The light guide element according to claim 1, wherein the soft-light part and the light-transmissible part are produced by using a double injection process, or the soft-light part and the light-transmissible part are connected with each other by using a hot melt process, or the soft-light part and the light-transmissible part are combined together by using a gluing process.

4. The light guide element according to claim 1, wherein the soft-light part further comprises a third soft-light part surface, wherein at least a portion of the third soft-light part surface is arranged between the first soft-light part surface and the second soft-light part surface, and a light-shading plate is disposed on the third soft-light part surface.

5. An electronic device, comprising:
a circuit module providing an electronic function;
at least one light-emitting element providing plural light beams; and
a light guide element comprising:
a soft-light part comprising a first soft-light part surface, a second soft-light part surface and plural scattering particles, wherein after plural light beams from the at least one light-emitting element enters the soft-light part through the first soft-light part surface, the plural light beams are uniformly diffused by the plural scattering particles, and first-portion light beams of the plural light beams are exited from the soft-light part through the second soft-light part surface; and
a light-transmissible part connected with the soft-light part, and comprising a first light-transmissible part surface, a second light-transmissible part surface and a third light-transmissible part surface, wherein the first light-transmissible part surface faces the second soft-light part surface, and the first-portion light beams enter the light-transmissible part through the first light-transmissible part surface after the first-portion light beams are exited from the second soft-light part surface, wherein at least a portion of the third light-transmissible part surface is a polished flat surface and arranged between the first light-transmissible part surface and the second light-transmissible part surface, wherein after the first-portion light beams enter the light-transmissible part, a small proportion of the first-portion light beams are exited from the light-transmissible part through the third light-transmissible part surface, and a large proportion of the first-portion light beams are exited from the light-transmissible part through the second light-transmissible part surface and outputted from the electronic device.

6. The electronic device according to claim 5, wherein the electronic device is a mouse device and the electronic function is a pointing function, or the electronic device is a keyboard device and the electronic function is an input function.

7. The electronic device according to claim 5, wherein the soft-light part further comprises at least one recess, and the at least one light-emitting element is accommodated within the at least one recess, wherein the first soft-light part surface is an inner surface of the at least one recess.

8. The electronic device according to claim 5, wherein the soft-light part is made of polymethylmethacrylate (PMMA), polycarbonate(PC), polystyrene (PS), polypropylene (PP) or acrylonitile-butadiene-styrene (ABS), or the light-transmissible part is made of polymethylmethacrylate (PMMA), polycarbonate(PC), polystyrene (PS), polypropylene (PP) or acrylonitile-butadiene-styrene (ABS).

9. The electronic device according to claim 5, wherein the soft-light part and the light-transmissible part are produced by using a double injection process, or the soft-light part and the light-transmissible part are connected with each other by using a hot melt process, or the soft-light part and the light-transmissible part are combined together by using a gluing process.

10. The electronic device according to claim 5, wherein the soft-light part further comprises a third soft-light part surface, wherein at least a portion of the third soft-light part surface is arranged between the first soft-light part surface and the second soft-light part surface, and a light-shading plate is disposed on the third soft-light part surface.
